(19) United States
(12) Patent Application Publication
(10) Pub. No.: US 2015/0317963 A1
(43) Pub. Date: Nov. 5, 2015

(54) Cymbal Skin

(71) Applicant: Timothy Joseph Smith, Nashville, TN (US)

(72) Inventor: Timothy Joseph Smith, Nashville, TN (US)

(21) Appl. No.: 14/265,899

(22) Filed: Apr. 30, 2014

(51) Int. Cl. G10D 13/06; G10D 13/02

(52) U.S. Cl. CPC G10D 13/06; G10D 13/022; G10D 13/065

(57) ABSTRACT

CYMBAL SKIN is a one-piece removable disc-like muffling device for the percussion instrument known as a cymbal. It will be made from pliable, stretchy gum rubber approximately ⅛″ thick. The main body and surface texture will be smooth. The disc will stretch around the cymbal's circumference and “tuck” under its edge.

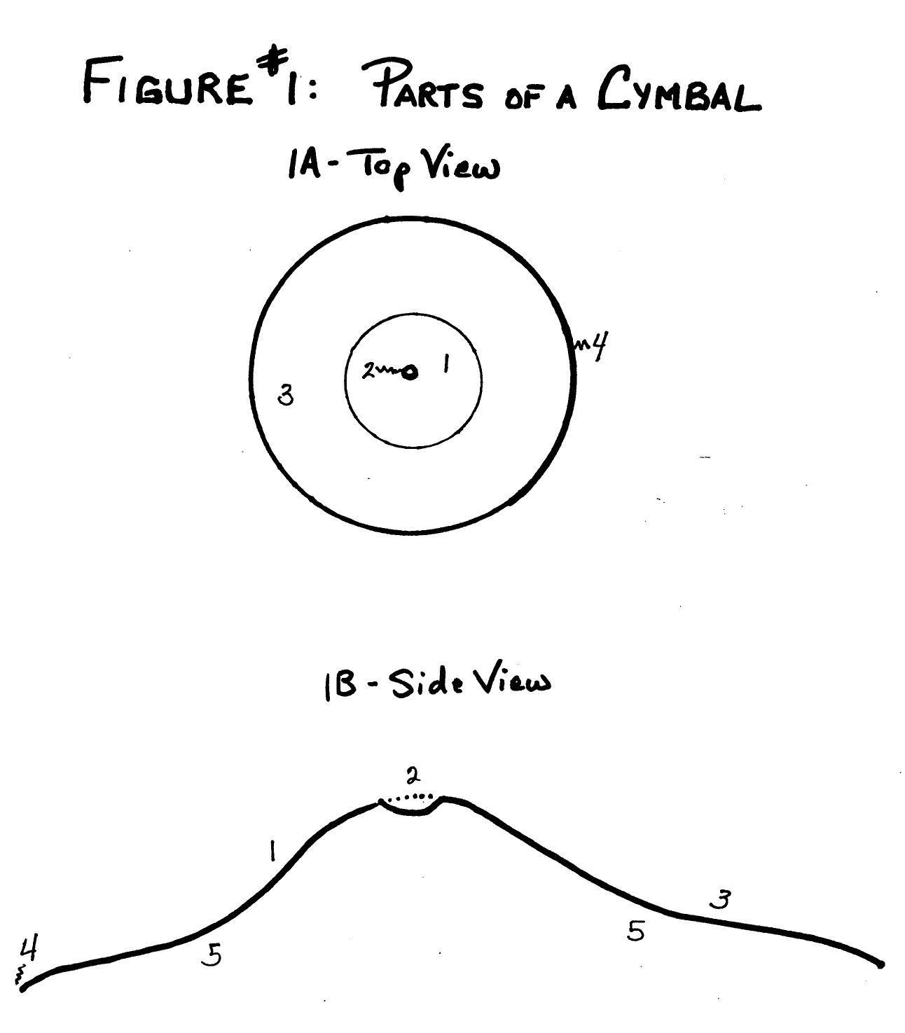

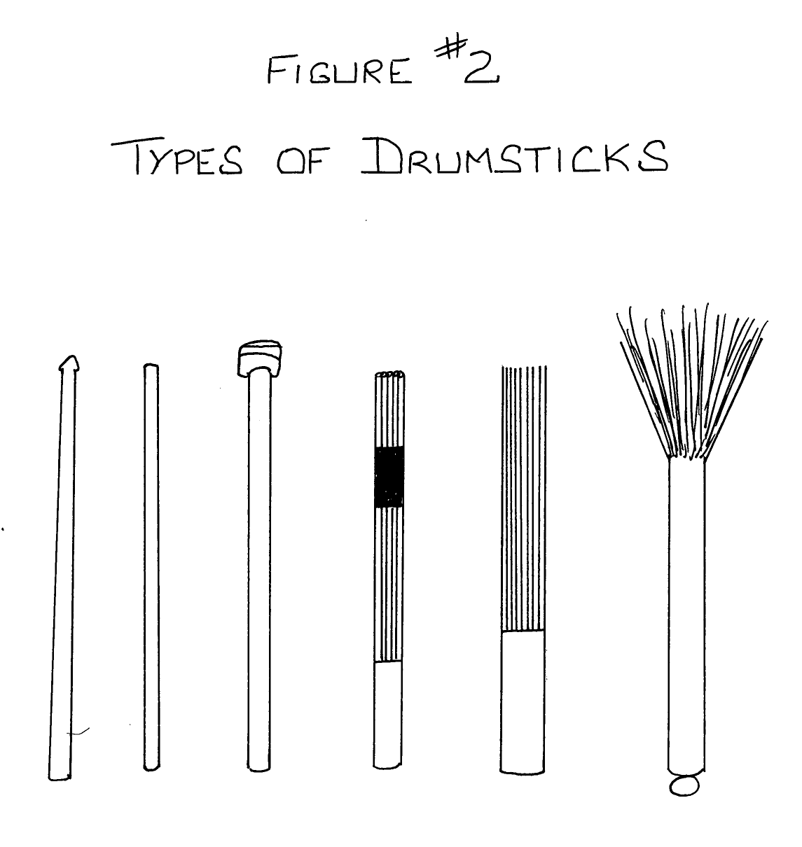

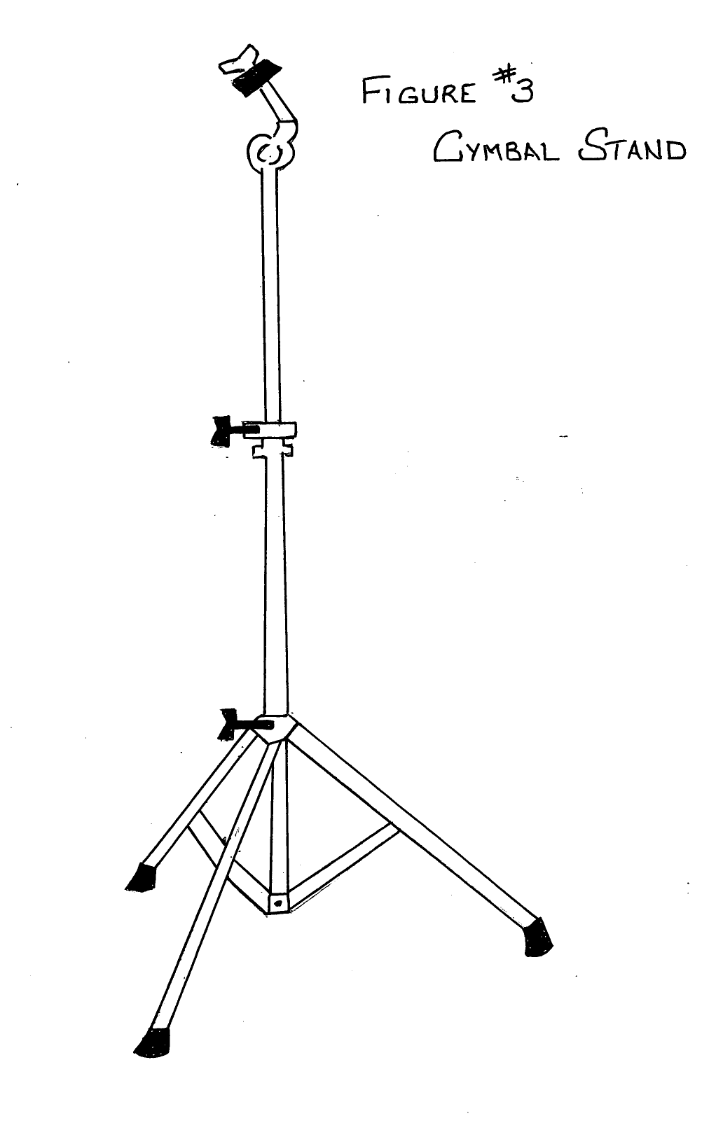

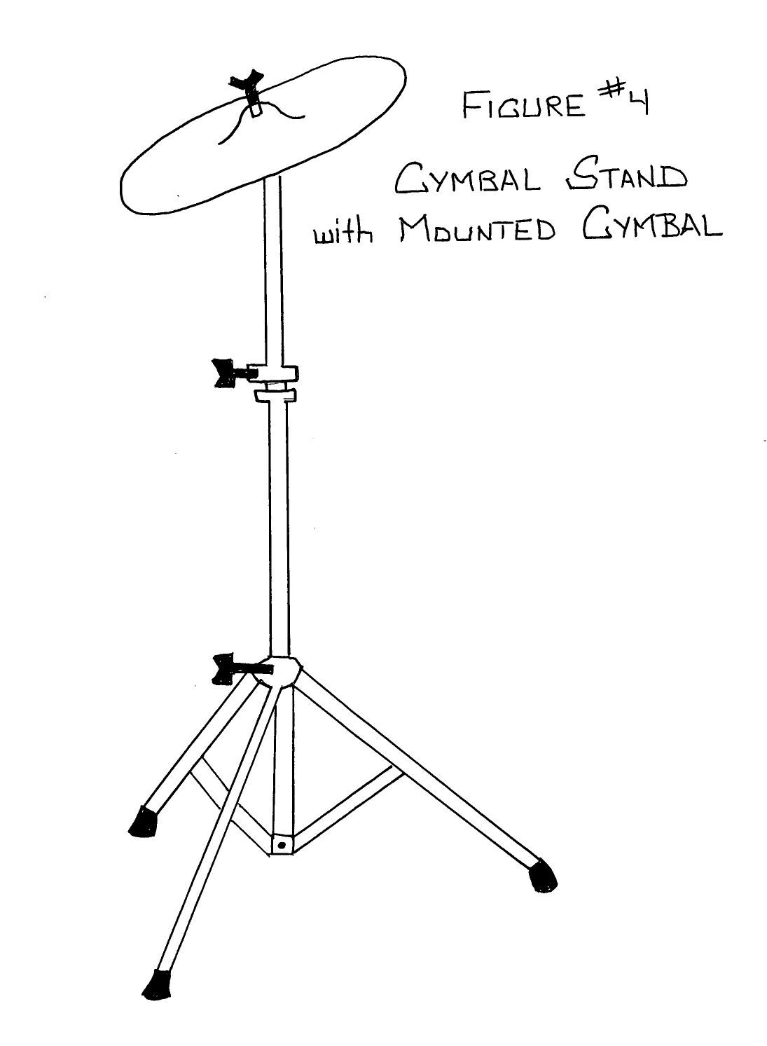

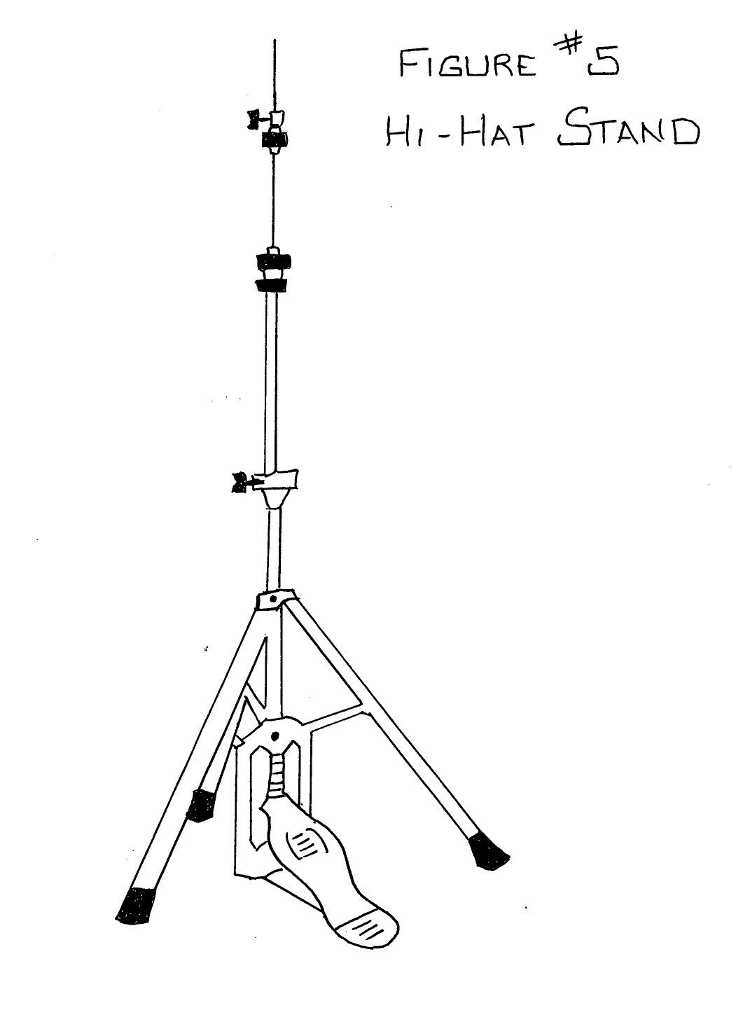

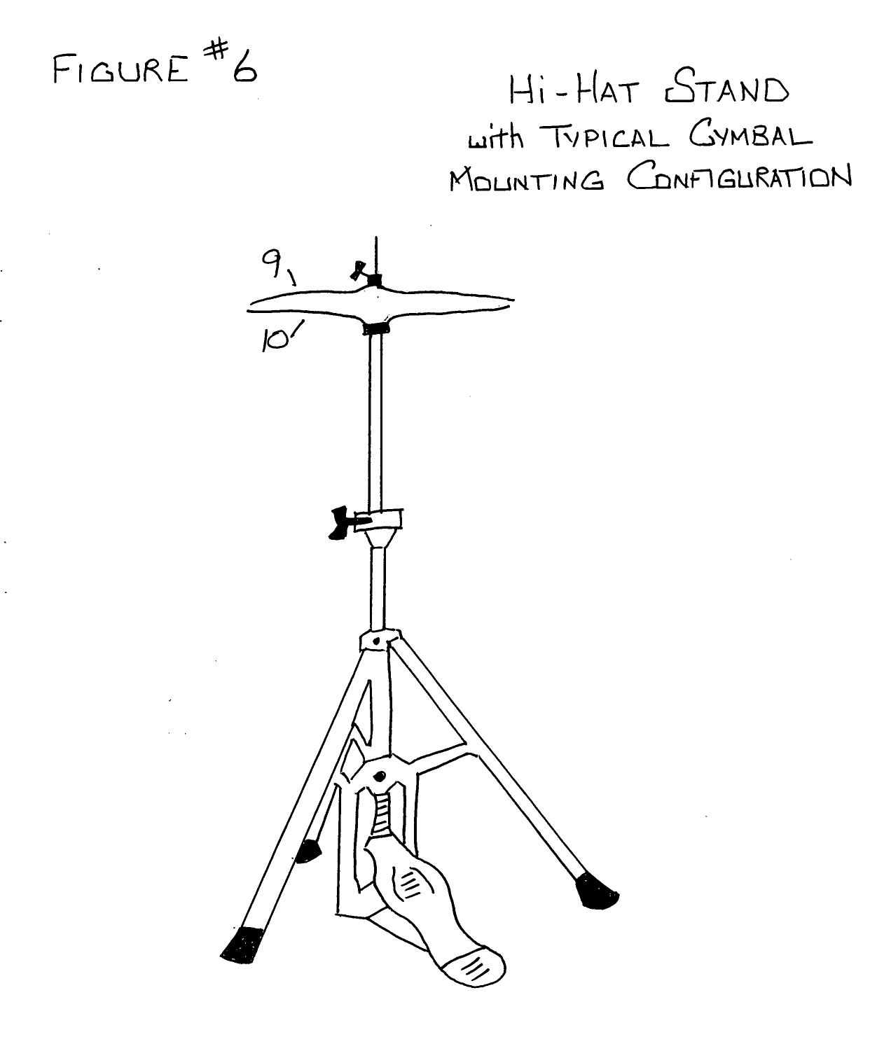

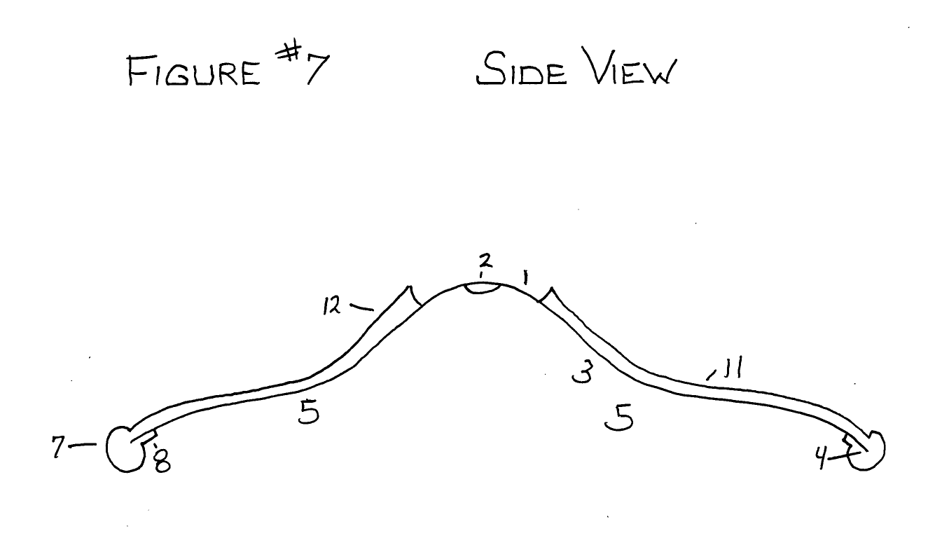

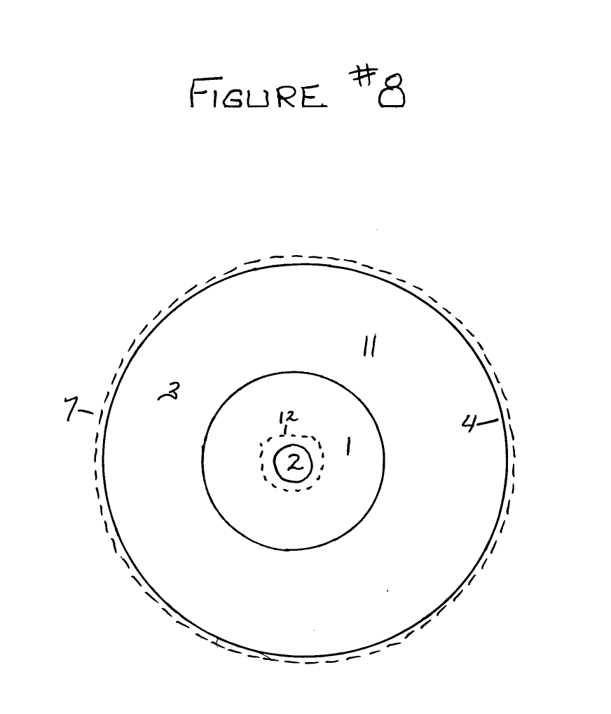

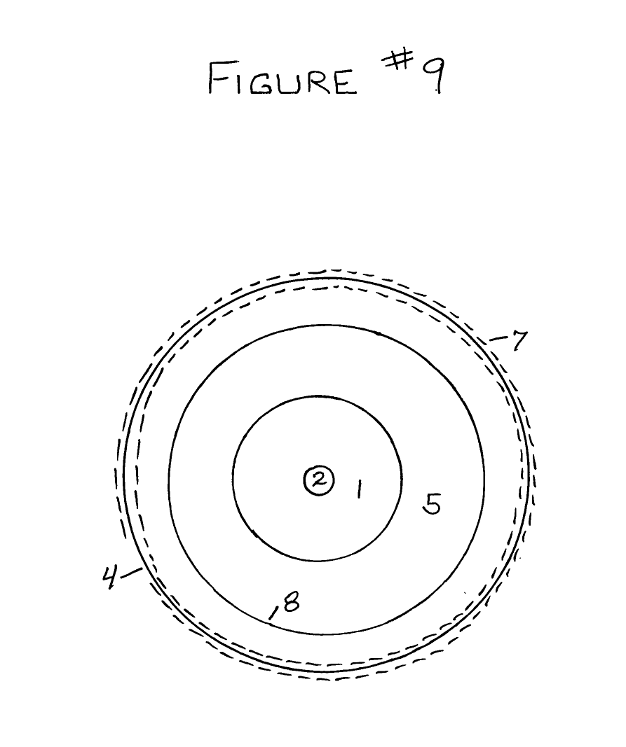

The material surrounding the cymbal bell will be upraised from the main body to resemble a “turtle-neck” look; providing an additional playing surface for the musician/drummer.

The material following and curling under the outer edge of the cymbal will also have an upraised buildup called a “reinforcement ring.” Visually, this reinforcement ring will resemble that of pizza dough. The reinforcement ring serves to add strength to the device design so the long-term damaging affects of being struck by a drumstick will be minimized.

Cymbal Skins will be produced in 15 different diameter sizes (in inches) ranging from 6 to 24.

### A. BACKGROUND

1. Background/Purpose of the Invention

This invention relates to a percussion instrument known as a cymbal. The invention is a silencing and muffling practice device, to which such a purpose is to significantly reduce and/or eliminate the sound volume produced while maintaining a realistic and authentic feel for the practicing drummer/player.

2. Description of Related Art

The process of practicing/playing a set of drums with accompanying cymbals without the aid of some sort of muffling device is frequently frowned upon, usually protested and overall objectionable to those within hearing range of the practicing musician. The practicing drummer is therefore increasingly hindered in his/her ability to improve their craft/talent/skills due to the accompanying noise factor. It also limits the types and locations where they might be allowed to dwell/reside. It is, therefore, the purpose if this invention to provide means for use during cymbal playing/practice which substantially reduces and/or eliminates the sound volume produced while providing natural, realistic feel and response/rebound for the player. Although there are known prior devices that achieve sound muffling of a cymbal, none are completely satisfactory in that they are either lacking in authentic playing “feel”, are relatively complex to assemble to and disassemble from a cymbal, or are prohibitively expensive to manufacture. This invention addresses and satisfies the problematic issues.

### C. BRIEF SUMMARY OF THE DRAWINGS

FIG. #1 depicts detailed illustrations (top and side views) describing the integral parts of the percussion instrument known as a cymbal.

FIG. #2 shows examples of the types of drumsticks, mallets, brushes, etc a musician would typically use to strike/play a cymbal.

FIG. #3 shows a percussion accessory known as a Cymbal Stand. It is used for suspending a cymbal, so it may hang unencumbered for maximum sound, tone and musical potential and ease of proximity for the player/musician.

FIG. #4 shows a typical cymbal stand with a mounted cymbal.

FIG. #5 shows a percussion accessory known as a Hi-Hat Stand. It is a spring-loaded, foot pedal-driven device used for mounting the two opposing (top & bottom) cymbals known as hi-hats.

FIG. #6 shows a typical hi-hat cymbal mounting configuration consisting of top and bottom cymbal arrangement.

FIG. #7 shows a side view of the invention device installed on a cymbal

FIG. #8 shows a top view of the invention device installed on a cymbal

FIG. #9 shows a bottom view of the invention device installed on a cymbal

### D. DETAILS

The present invention is most advantageous when properly attached to a metal disc made of various mixtures of alloys; ranging from 6-24 inches in diameter (i.e. a cymbal) (FIG. #1: Parts of a Cymbal). The cymbal is generally suspended via a central “hole” (2) on the cymbal “bell” (1) by a cymbal stand.

(FIG. #3: Cymbal Stand) The cymbal is typically struck a majority of the time on the upper major surface or “bow” (3) with a drumstick, mallet, brush or other appropriate “stick” or striking utensil (FIG. #2: Drumstick Types). The cymbal is also frequently struck on the uppermost curved bell (1) and on the outermost “edge.” (4)

Cymbals can also be played in a configuration known as the “hi-hat.” (FIG. #5: Hi-Hat Stand) This is described as the arrangement of two cymbals mounted on a common shaft. (FIG. #6: Hi-Hat Configuration) One cymbal is mounted right side up (9) (the bell (1) is on top and visible) and the second cymbal is mounted upside down (10) (the bell (1) is on the bottom and not clearly visible). The hi-hat stand is generally equipped with a spring-loaded foot pedal device which, when depressed, causes the top cymbal (9) to descend and make contact with the bottom cymbal (10).

### E. SUMMARY OF THE INVENTION

The device of the present invention consists of a one-piece circular sheet of flexible rubber (11), approximately ⅛ of an inch in thickness in most places which will cover the cymbal bow (3) and curl under and around the cymbal edge (4). The material will extend upward along the cymbal surface and create a slightly thicker “turtleneck” like covering (12), hugging a majority of the cymbal bell (1). A centralized opening in the device permits receipt over, yet allowing exposure of the center hole (2) point of the cymbal bell (1) and a portion of the cymbal bell (1), thus allowing the cymbal to be hung/suspended without impairment on a stand designed for such a purpose. (FIG. #4: Cymbal Stand with Mounted Cymbal).

The device circumference is virtually identical to that of the cymbal or very slightly smaller. The device material will extend over the entire cymbal surface toward the outer edge (4) of the cymbal's circumference. Near the cymbal edge (4) the device will then form a thicker section of molded, reinforced rubber material. This “reinforcement ring” (7) will visually resemble a “pizza dough” look and will wrap around the cymbal edge (4) and make contact with the under surface of the cymbal (5). This rounded, bulbous design feature allows the cymbal edge (4) to tuck and wedge itself inside the fold of the device (8). This action will slightly stretch the device's circumference, thus allowing a snug/grip fit to the cymbal and virtually zero chance of the device falling away from the cymbal surface during play or practice. The reinforcement ring (7) feature also serves to add strength, stability and longevity to the device, as the consistent striking of a stick to a cymbal's edge could cause a thinner material to be cut and damaged, rendering the muffling device less effective.

### F. ASSEMBLY/ATTACHING DEVICE TO A CYMBAL

Refer to FIG. #7: Side View. The device's central opening is placed around/over the cymbal's top/upper surface, with the cymbal bell (1) and cymbal hole (2) exposed. The remainder device material extends over the cymbal bow (3). The outer edge portion of the device is then stretched and folded under the cymbal edge (4), with the remaining device material making contact and gripping the underneath side (5) of the cymbal surface. The result is, during practice, drumsticks may strike the upper surface or edge of the protected cymbal without producing the typical penetrating sound volume associated with the musical instrument (cymbal).

When the described device is placed on the upper cymbal of a hi-hat cymbal configuration (FIG. #6: Hi-Hat Configuration), the upper/top cymbal (9) is prevented from making a noise when struck with a drumstick. In addition, the device's protective reinforcement ring (7) edge, which extends underneath the edge (4) of the top cymbal (9), insulates the two cymbals (9 & 10) from metal-to-metal contact, thus eliminating sounds of any significant volume. Increased muffling may be achieved in a hi-hat configuration by attaching a device to the bottom cymbal (10) of the configuration as well.

I claim:

1. A device which is constructed as a one-piece covering for a percussion instrument known as a cymbal comprising:
a circular disc, made of a pliable, stretchy gum rubber, approximately ⅛ of an inch in thickness. The main body and surface texture will be smooth.

2. The cymbal as in claim 1 is a metallic circular disc made in various diameters ranging from 6 to 24 inches (and larger) and typically made from a mixture of metal alloys consisting mainly of copper, tin and silver. Other materials such as brass and bronze can also be used.

3. The cymbal as in claim 1 has 5 (five) distinctive names parts or sections. Those being: 1: a small central hole; 2: the bell; 3: the bow; 4: the edge; 5: under surface

4. A device as in claim 1, looks like a flat circular disc with a hole in the middle.

5. A device as in claim 1 will be constructed of a flexible, rubber material approximately ⅛ of an inch in thickness in most places.

6. A device as in claim 1, the disc will stretch around the circumference of the cymbal and “tuck” under and around the cymbal edge.

7. A device as in claim 4 will expose a portion of the cymbal bell and the small central hole.

8. A device as in claim 1 will have the rubber material surrounding a portion of the middle bell be upraised from the main body to resemble a “turtle-neck” look. The edge of this upraised section will be reinforced by a thicker, more pronounced section of rubber.

9. A device as in claim 8 (turtle neck) will serve to add strength to the upper, inner edge of the muffling device, which rests against the cymbal bell; while also providing an additional playing surface for the player/musician against the cymbal bell.

10. A section of the device as in claim 7 (turtle neck) will be approximately ¼ of an inch in thickness

11. A device as in claim 1 will have an upraised buildup of rubber material following the outer circumference of the cymbal. This is called a “reinforcement ring” which will curl under the cymbal's edge. Visually, this reinforcement ring will resemble the edge of pizza dough. Once curled under the cymbal edge, it will form a lip with an inside groove. The cymbal edge will seat inside this groove.

12. A section of the device as in claim 8 (reinforcement ring) will be approximately ½ to ⅝ of an inch in thickness

13. A device as in claim 4 will create tension by the stretched material around the cymbal circumference which will hold the device in place. No adhesive material will be needed.

14. A device as in claim 1, when installed on a cymbal will serve as a muffling apparatus to greatly reduce or eliminate the sound volume normally associated with the unencumbered playing of the musical instrument.

15. A device as in claim 13 is typically played upon through the use of various styles of percussion drumsticks, mallets, brushes and the like.
